(19) United States
(12) Patent Application Publication
(10) Pub. No.: US 2004/0212705 A1
(43) Pub. Date: Oct. 28, 2004

(54) Method and apparatus for defect compensation in an image sensor

(76) Inventor: Chih-Cheng Hsieh, Hsin-Chu (TW)

Correspondence Address: RABIN & Berdo, PC, 1101 14TH STREET, NW, SUITE 500, WASHINGTON, DC, 20005, US

(21) Appl. No.: 10/634,850

(22) Filed: Aug. 6, 2003

(30) Foreign Application Priority Data
Apr. 23, 2003 (TW) 92109465

(51) Int. Cl. H04N 5/335; H04N 9/64

(52) U.S. Cl. 348/272

(57) ABSTRACT

A method for defect compensation in a color image sensor having pixels. The method comprises the steps of predetermining a first and second threshold, and defining a window, identifying peak and normal pixels, wherein the peak is one of the pixels that has a color difference larger than the first threshold from two adjacent pixels of the same color, and the normal pixels are those other than the peak, identifying the peak as a defect if each of the two pixels immediately adjacent to the peak has a color difference smaller than the second threshold from two adjacent pixels of the same color, and all the pixels in the window positioned according to the location of the peak are normal pixels, and correcting a color value of the defect.

### BACKGROUND OF THE INVENTION

1. Field of the Invention

The present invention relates to defect compensation in an image sensor and particularly to a method and apparatus for defect compensation in a color image sensor without using large memory or line buffer.

2. Description of the Prior Art

The CMOS image sensor is an innovative sensing technique compared to the traditional CCD, as it offers lower power consumption, higher system integration capability, and CMOS process compatibility. However, the CMOS image sensor suffers from weak defects, warm pixels, and poor FPN performance due to the difficulties in controlling the CMOS process. Despite these drawbacks, the high resolution CMOS image sensor is rapidly gaining popularity in the DSC market due to its low cost, because of this, the defect compensation performance of the CMOS image sensor has become a key issue.

There are two main types of defect compensation used in CMOS image sensors. One is in-process calibration and the other is on-chip compensation.

With in-process calibration, the locations of the defective pixels are identified by testing the pixel array and permanently stored in a memory device in the sensor. When the processor receives image data from the pixel array, it reads the defect information from memory and accordingly corrects the values of the defective pixels so that the compensated image data is finally output from the sensor. This advantage of this is that the defective locations are already known and the processor never wrongly locates the defects. However, in-process calibration raises a need for additional memory to store the defect information, which increases the cost of the sensor.

With on-chip compensation, the locations of the defective pixels are identified in real time. When the processor receives image data from the pixel array, it locates the possible defects by a specific algorithm and corrects the values of the located defective pixels so that the compensated image data is finally output from the sensor. The advantage of this is that no memory is required to permanently store the defective locations. However, on-chip compensation easily results in image distortion due to normal pixels being mistakenly identified as the defects. For example, if the original image includes a column of dark pixels as shown in FIG. 1A, the processor will mistakenly identify these dark pixels as defects since they are “peaks” compared to their adjacent pixels. Thus, these pixels are “corrected” so that the line in the original image disappears, as shown in FIG. 1B. Further, conventional on-chip compensation also raises a need for a line buffer to temporarily store essential data for calculations in the algorithm, which increases the cost of the sensor.

### SUMMARY OF THE INVENTION

The object of the present invention is to provide a method and apparatus for on-chip defect compensation of a color image sensor without using a large memory or line buffer.

The present invention provides a method for defect compensation in a color image sensor having pixels. The method comprises the steps of predetermining a first and second threshold, and defining a window, identifying peak and normal pixels, wherein the peak is one of the pixels that has a color difference larger than the first threshold from two adjacent pixels of the same color, and the normal pixels are those other than the peak, identifying the peak as a defect if each of the two pixels immediately adjacent to the peak has a color difference smaller than the second threshold from two adjacent pixels of the same color, and all the pixels in the window positioned according to the location of the peak are normal pixels, and correcting a color value of the defect.

The present invention also provides an apparatus for defect compensation in a color image sensor having pixels, the apparatus comprising a memory device, and a processor implementing the steps of predetermining a first and second threshold, and defining a window, identifying peak and normal pixels, wherein the peak is one of the pixels that has a color difference larger than the first threshold from two adjacent pixels of the same color, and the normal pixels are those other than the peak, storing a plurality of data bits in the memory device, wherein each of the data bits indicates one peak and one normal pixel, identifying the peak as a defect if each of the two pixels immediately adjacent to the peak has a color difference smaller than the second threshold from two adjacent pixels of the same color, and all the pixels in the window positioned according to the location of the peak are normal pixels, and correcting a color value of the defect.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1A and 1B show mistakenly identified defects resulting from the conventional on-chip compensation.

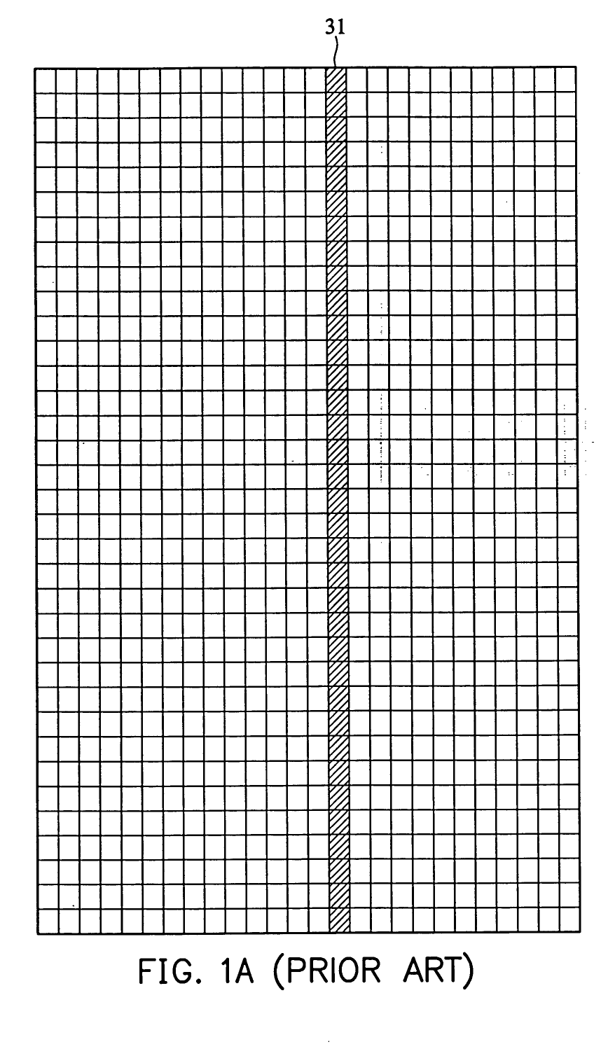

FIG. 2 shows a 16*16 color pixel array.

FIG. 3 is a flowchart of a method for defect compensation in a color image sensor according to one embodiment of the invention.

FIG. 4 shows an apparatus for defect compensation in a color image sensor according to one embodiment of the invention.

### DETAILED DESCRIPTION OF THE INVENTION

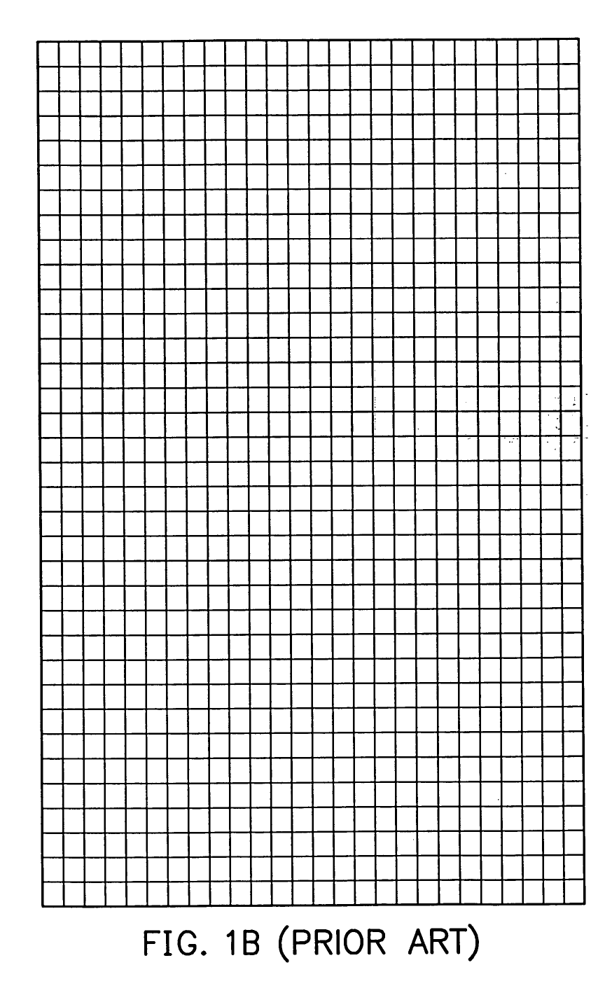

A general procedure for on-chip compensation according to one embodiment of the invention will be with reference to FIG. 2 which shows a 16*16 color pixel array. The following procedure is iterated for each of the pixels in the array.

First, it is determined whether the currently selected pixel is a peak. The current pixel is identified as a peak if it has a difference larger than a threshold T1 from two adjacent pixels of the same color; otherwise, it is a normal pixel. For example, the currently selected pixel is (5,6). It is a peak if |(5,6)-(5,4)|>T1 and |(5,6)-(5,8)|>T1; otherwise the pixel (5,6) is a normal pixel.

Second, it is further determined whether the identified peak is a defect. A peak is identified as a defect if it meets the following criteria:

1. Each of the two pixels immediately adjacent to the peak has a color difference smaller than a threshold T2 from two adjacent pixels of the same color;

2. All the other pixels in a pre-defined window positioned according to the location of the peak are normal pixels.

For example, the pixel (5,6) is identified as a peak in the first step. It is a defect if |(5,5)-(5,3)|<T2, |(5,7)-(5,5)|<T2 and |(5,9)-(5,7)|<T2, and all the other pixels in the window (4,2)˜(5,D) are normal pixels, wherein the window is pre-defined as a matrix formed by the pixels located within 7 columns right and 4 columns left of the peak, and the row of and immediately above the peak.

Third, the color value of the defect is corrected as a mean of the color values of two adjacent pixels of the same color. For example, the pixel (5,6) is identified as a defect in the second step. Its color value is corrected as the mean of the color values of the pixels (5,4) and (5,8).

The thresholds T1 and T2 are programmable and the window may be defined as required. Further, the color value of the defect may be corrected in other ways and is not limited to the mean of adjacent pixel values.

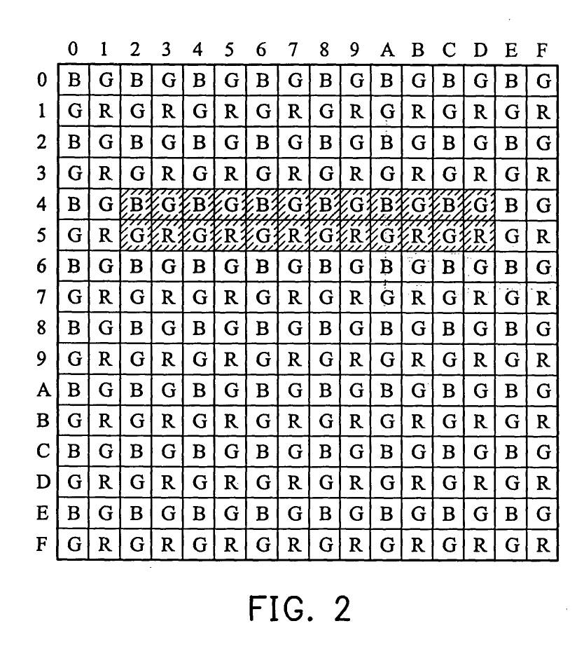

The method for defect compensation in a color image sensor according to one embodiment of the invention will be more specifically described with reference to FIG. 3.

In step 51, the thresholds T1 and T2 are predetermined and the window is pre-defined as a matrix composed of the pixels within columns and rows extended from a reference pixel. For example, the window is defined as a matrix composed of the pixels within 7 columns right and 4 columns left of the reference pixel (5,6), and the row of and immediately above the reference pixel (5,6), as shown in FIG. 2.

In step 52, as the pixel data is read out from the array, each of the pixels is checked to determine whether it is a peak. The pixel is identified as a peak if it has differences larger than the threshold T1 from two adjacent pixels of the same color; otherwise, it is a normal pixel. In the 16*16 color pixel array shown in FIG. 2, when the row 5 is read out and the pixel (5,6) is to be checked, the color differences respectively between the green pixels (5,6) and (5,8), (5,6) and (5,4) are compared to the threshold T1. If they are both larger than T1, the pixel (5,6) is identified as a peak and an indication bit “1” for the pixel (5,6) is stored in a buffer; otherwise, the pixel (5,6) is a normal pixel and its indication bit is “0”.

In step 53, if the pixel is identified as a peak, the pixel is further checked to determine whether it is defective before checking the next pixel in the row. The peak is identified as a defect if each of the two pixels immediately adjacent to the peak has a color difference smaller than the threshold T2 from two adjacent pixels of the same color, and all the other pixels in the pre-defined window positioned by using the peak as a reference pixel are normal pixels. In the 16*16 color pixel array shown in FIG. 2, if the pixel (5,6) is identified as a peak, it should be further checked to determine whether it is a defect. The pixels immediately adjacent to the peak (5,6) are red pixels (5,5) and (5,7) so that the color differences between the red pixels (5,3) and (5,5), (5,7) and (5,5), (5,5) and (5,7), and (5,9) and (5,7) are compared to the threshold T2. By the indication bits stored in the buffer, it is also determined whether all the other pixels in the window positioned by using the peak (5,6) as a reference pixel are normal pixels. If it is true and all the color differences are smaller than the threshold T2, the peak (5,6) is identified as a defect.

In step 54, the color value of each identified defect is corrected as the mean of the color values of two adjacent pixels of the same color. The color value of the defective green pixel (5,6) is corrected as the mean of the color values of the adjacent green pixels (5,4) and (5,8).

The previously described defect compensation also applies to gray scale images and color images composed of magenta, yellow and cyan pixels.

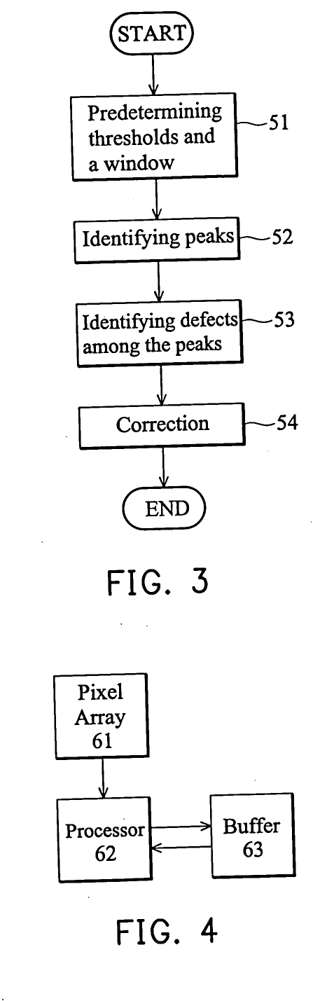

FIG. 4 shows an apparatus for defect compensation in a color image sensor according to one embodiment of the invention. It includes a processor 62 and a buffer 63. The processor 62 reads out the data of rows of pixels from the pixel array 61 and carries out the method shown in FIG. 3. The buffer 63 stores the indication bits of the pixels. The buffer 63 may reside in the pixel array 61 or processor 62.

It is noted that the size of the buffer 63 is much smaller than that of the line buffer used in conventional on-chip compensation. Only one indication bit for each of the pixels need to be stored in the buffer 63 while all the bits of the color value of each pixel are stored in the line buffer in conventional defect compensation. Thus, for an 8-bit color image, the buffer size for defect compensation in the present invention is ⅛ of that for the conventional defect compensation. Furthermore, unlike the conventional defect compensation wherein a peak is directly regarded as a defect, the peak is further checked to determine whether it should be identified as a defect, which decreases the number of mistakenly identified defects.

In conclusion, the present invention provides a method and apparatus for on-chip defect compensation of a color image sensor without using large memory or line buffer. The peaks are identified by a 1-D algorithm and only one indication bit for each peak is stored in the buffer. The defects are identified further by the 1-D algorithm using the peak information in the buffer. This eliminates the need for a large line buffer to store the values of the pixels and decreases the cost of the sensor.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for defect compensation in a color image sensor having pixels, the method comprising the steps of:
predetermining a first and second threshold, and defining a window;
identifying peak and normal pixels, wherein the peak is one of the pixels that has a color difference larger than the first threshold from two adjacent pixels of the same color, and the normal pixels are those other than the peak;
identifying the peak as a defect if each of the two pixels immediately adjacent to the peak has a color difference smaller than the second threshold from two adjacent pixels of the same color, and all the other pixels in the window positioned according to the location of the peak are normal pixels; and
correcting a color value of the defect.

2. The method as claimed in claim 1 further comprising the step of:
storing a plurality of data bits, each of which indicates one peak and one normal pixel.

3. The method as claimed in claim 1, wherein the pixels are red, blue and green.

4. The method as claimed in claim 1, wherein the pixels are red, yellow and cyan.

5. The method as claimed in claim 1, wherein the color image sensor is a CMOS sensor.

6. The method as claimed in claim 1, wherein the color value of the defect is corrected as a mean of the color values of two adjacent pixels of the same color.

7. The method as claimed in claim 1, wherein the first and second threshold, and the window are programmable.

8. An apparatus for defect compensation in a color image sensor having pixels, the apparatus comprising:
a memory device; and
a processor implementing the steps of:
predetermining a first and second threshold, and defining a window;
identifying peak and normal pixels, wherein the peak is one of the pixels that has a color difference larger than the first threshold from two adjacent pixels of the same color, and the normal pixels are those other than the peak;
storing a plurality of data bits in the memory device, wherein each of the data bits indicates one peak and one normal pixel;
identifying the peak as a defect if each of the two pixels immediately adjacent to the peak has a color difference smaller than the second threshold from two adjacent pixels of the same color, and all the other pixels in the window positioned according to the location of the peak are normal pixels; and
correcting a color value of the defect.

9. The apparatus as claimed in claim 8, wherein the pixels are red, blue, and green.

10. The apparatus as claimed in claim 8, wherein the pixels are red, yellow, and cyan.

11. The apparatus as claimed in claim 8, wherein the color image sensor is a CMOS sensor.

12. The apparatus as claimed in claim 8, wherein the color value of the defect is corrected as a mean of the color values of two adjacent pixels of the same color.

13. The apparatus as claimed in claim 8, wherein the first and second threshold, and the window are programmable.

14. A method for defect compensation in an image sensor having pixels, the method comprising the steps of:
predetermining a first and second threshold, and defining a window;
identifying peak and normal pixels, wherein the peak is one of the pixels that has differences larger than the first threshold from two adjacent pixels, and the normal pixels are those other than the peak;
identifying the peak as a defect if each of the two pixels adjacent to the peak has differences smaller than the second threshold from two adjacent pixels, and all the other pixels in the window positioned according to the location of the peak are normal pixels; and
correcting a value of the defect.

15. The method as claimed in claim 14 further comprising the step of:
storing a plurality of data bits, each of which indicates one peak and one normal pixel.

16. The method as claimed in claim 14, wherein the image sensor is a CMOS sensor.

17. The method as claimed in claim 14, wherein the value of the defect is corrected as a mean of the values of two adjacent pixels.

18. The method as claimed in claim 14, wherein the first and second threshold, and the window are programmable.
